(19) United States
(12) Patent Application Publication
(10) Pub. No.: US 2024/0198286 A1
(43) Pub. Date: Jun. 20, 2024

(54) SODA MAGCITE COMPOSITION, METHODS OF MANUFACTURE AND USE IN CARBON DIOXIDE (CO2) SEQUESTRATION

(71) Applicant: ASPIRING MATERIALS LIMITED, Christchurch (NZ)

(72) Inventors: Allan Charles Nye SCOTT, Christchurch (NZ); Christopher John-Paul OZE, Christchurch (NZ)

(73) Assignee: ASPIRING MATERIALS LIMITED, Christchurch (NZ)

(21) Appl. No.: 18/406,968

(22) Filed: Jan. 8, 2024

Related U.S. Application Data
(62) Division of application No. 17/945,358, filed on Sep. 15, 2022, now Pat. No. 11,890,572.

(51) Int. Cl. B01D 53/62

(52) U.S. Cl. CPC B01D 53/62; B01D 2253/106; B01D 2253/1122; B01D 2257/504

(57) ABSTRACT

Described herein is a soda magcite composition, methods of manufacture of soda magcite compositions and use of soda magcite for carbon dioxide sequestration. The soda magcite composition comprises a mixture of magnesium hydroxide, metal hydroxide and water to create a composition that is highly effective at sequestering carbon dioxide.

This application is a divisional of U.S. Utility patent application Ser. No. 17/945,358, filed on 15 Sep. 2022, the specification of which is hereby incorporated herein by reference.

### BACKGROUND OF THE INVENTION

### Field of the Invention

Described herein is a soda magcite composition, methods of manufacture of soda magcite compositions and use of soda magcite for carbon dioxide (CO₂) sequestration.

### Description of the Related Art

Carbon dioxide (CO₂) emissions are a key driver of climate change and ways to minimise or avoid such emissions are of heightened interest. One method of reducing CO₂ emissions is to sequester or capture the CO₂ before it enters the atmosphere.

Soda lime is a compound that has been used to sequester CO₂ from industrial systems as well as to maintain breathable air in enclosed spaces.

Soda lime is effective at removing CO₂ at low and high concentrations.

Soda lime is not practical for large scale carbon sequestration as a means of reducing global CO₂ levels. Existing sequestrants such as soda lime are capable of sequestering CO₂; however, the method of soda lime production from calcium carbonates releases CO₂. Hence, there is no benefit for using soda lime as a net zero to negative CO₂ sequestrant. The reason for the above loss of CO₂ during manufacture is that the source of material for soda lime is typically a carbonate mineral which evolves CO₂ during production. There is also a considerable energy requirement to convert the carbonate into soda lime which may also contribute to the release of CO₂ via combustion of fossil fuels.

Ideally, a CO₂ sequestrant should be sourced from a non-carbonate material and/or have a manufacturing process that does not release CO₂, resulting in a net sequestration of CO₂.

Further aspects and advantages of the soda magcite composition, methods of manufacture and methods of CO₂ sequestration will become apparent from the ensuing description that is given by way of example only.

### BRIEF SUMMARY OF THE INVENTION

A soda magcite composition, methods of manufacture of soda magcite compositions and use of soda magcite for carbon dioxide sequestration are described herein. The soda magcite composition may comprise a mixture of magnesium hydroxide, metal hydroxide and water to create a soda magcite composition that may be highly effective at sequestering carbon dioxide. Further, soda magcite may be manufactured in a variety of ways that do not release CO₂ during manufacture.

In a first aspect, there is provided a soda magcite composition comprising:
magnesium hydroxide;
metal hydroxide; and
water.

In a second aspect, there is provided a method of manufacturing a soda magcite composition comprising:
selecting a magnesium hydroxide containing material;
selecting a metal hydroxide; and
mixing water with the magnesium hydroxide containing material and the metal hydroxide to form the soda magcite composition.

In a third aspect there is provided a method of manufacturing a soda magcite composition comprising:
selecting a magnesium containing silicate source;
subjecting the selected magnesium containing silicate source to acid wash, to produce an acid digested solution;
subjecting the acid digested solution to a base wash by adding a base solution to the acid digested solution to produce a magnesium salt solution and, during this step, removing silica, iron or other metals and minerals from the magnesium salt solution;
subjecting the magnesium salt solution to electrolysis to recover magnesium hydroxide;
mixing the recovered magnesium hydroxide with a solution containing metal hydroxide and water to produce the soda magcite composition.

In a fourth aspect there is provided a method of manufacturing a soda magcite composition comprising:
selecting a magnesium containing silicate source;
subjecting the selected magnesium containing silicate to an acid wash, to produce an acid digested solution;
subjecting the acid digested solution to a first base wash by adding a base solution to the acid digested solution to produce a magnesium salt solution and, during this step, removing silica, iron or other metals and minerals from the magnesium salt solution;
completing a further base wash to separate magnesium hydroxide in solution;
filtering the separate magnesium hydroxide in solution and recovering a magnesium hydroxide retentate and a permeate, the permeate substantially comprising metal salt in solution;
mixing the recovered magnesium hydroxide retentate with a solution comprising metal hydroxide and water to produce the soda magcite composition.

In a fifth aspect there is provided a method of manufacturing a soda magcite composition comprising:
selecting a magnesium containing silicate source;
subjecting the selected magnesium containing silicate source to a base wash by adding a base solution to the magnesium containing silicate source to produce a magnesium hydroxide solution;
mixing the recovered magnesium hydroxide with a solution containing metal hydroxide and water to produce the soda magcite composition.

In a sixth aspect, there is provided a method of sequestration of carbon dioxide CO₂ by:
selecting a soda magcite composition, the soda magcite composition comprising magnesium hydroxide, metal hydroxide, and water;
exposing the soda magcite composition to CO_{2;} and
wherein the soda magcite composition reacts with the CO₂ to form stable magnesium carbonates and hydrated magnesium carbonates and hence sequesters the CO₂.

The inventors have identified a soda magcite composition acts in a synergistic manner to sequester CO₂. Magnesium hydroxide materials do sequester CO₂. The inventors found that by mixing metal hydroxide and water with magnesium hydroxide, the rate of CO₂ sequestration by the magnesium hydroxide may rapidly accelerate, to the point of being a rapid and useful method of reducing CO₂ emissions. Sequestration may be by direct air capture or from a point source.

A further advantage identified is that the soda magcite composition may be made without the method itself producing CO₂, and hence negating any benefits of subsequent sequestration.

### BRIEF DESCRIPTION OF THE DRAWINGS

Further aspects of the soda magcite composition, methods of manufacture and methods of CO₂ sequestration will become apparent from the following description that is given by way of example only and with reference to the accompanying drawings in which:

FIG. 1 illustrates a flow diagram of a method of producing magnesium hydroxide along with subsequent manufacture of a soda magcite composition;

FIG. 2 illustrates a flow diagram of an alternative method of producing magnesium hydroxide along with subsequent manufacture of a soda magcite composition;

FIG. 3 illustrates a flow diagram of a further alternative method of producing magnesium hydroxide along with subsequent manufacture of a soda magcite composition;

FIG. 4 illustrates a flow diagram where solid soda magcite composition is used to sequester CO₂ where air is passed over the soda magcite composition material and where the soda magcite composition is in a pelletised form and reacts with carbon dioxide gas in the air to produce a hydrated magnesium carbonate end product;

FIG. 5 illustrates an apparatus for direct air capture according to the flow diagram of FIG. 4;

FIG. 6 illustrates a flow diagram of an alternative sequestration method using a slurry of soda magcite composition in a wet scrubber configuration where the slurry is distributed as a fine mist in a column of hot gas;

FIG. 7 illustrates a further flow diagram of a method of sequestration via bubbling of CO₂ through a slurry containing soda magcite composition; and

FIG. 8 illustrates a graph showing the results of a CO₂ sequestration trial.

### DETAILED DESCRIPTION OF THE INVENTION

As noted above, a soda magcite composition, methods of manufacture of soda magcite compositions and use of soda magcite for carbon dioxide sequestration are described. The composition may comprise a mixture of magnesium hydroxide, metal hydroxide and water to create a composition that may be highly effective at sequestering carbon dioxide.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘comprise’ and grammatical variations thereof shall have an inclusive meaning—i.e. that it will be taken to mean an inclusion of not only the listed components it directly references, but also other non-specified components or elements.

Reference is made hereafter to ‘soda magcite’ or grammatical variations thereof. This may also be called ‘sodium magnesium hydrate’. This compound may also be described as being a magnesium-based hydrate.

The term ‘alkali metals’ and grammatical variations thereof as used herein refers to both alkali and alkaline metals.

The term ‘hydrate’ and grammatical variations thereof as used herein refers to a compound, composition or substance that has variable amounts of water present.

### Soda Magcite Composition

In a first aspect, there is provided a soda magcite composition comprising:
magnesium hydroxide;
metal hydroxide; and
water.

The inventors have identified that the above composition acts in a synergistic manner to sequester CO₂. Magnesium hydroxide materials do sequester CO₂. The inventors found that by mixing metal hydroxide and water with magnesium hydroxide, the rate of CO₂ sequestration by the magnesium hydroxide may rapidly accelerate, to the point of being a rapid and useful method of reducing CO₂ emissions. Sequestration may be by direct air capture or from a point source.

### Magnesium Hydroxide

The magnesium hydroxide may be present as Mg(OH)₂. The magnesium hydroxide may be present as a hydrate of magnesium hydroxide.

The magnesium hydroxide may be obtained from magnesium silicate bearing minerals comprising: olivine, serpentine group minerals, pyroxenes, amphiboles, and combinations thereof.

The magnesium hydroxide may be obtained from minerals such as olivine. Olivine is a magnesium-rich silicate present in widely distributed mafic and ultramafic rock deposits.

For these reasons, olivine may be an ideal source material to manufacture magnesium hydroxide used to form the soda magcite.

The magnesium silicate bearing minerals may be sourced as: sands, sediment, rock, and combinations thereof. These material sources are common natural forms for magnesium silicate bearing materials.

The soda magcite composition may comprise approximately 1-99%, or 5-95%, or 20-90%, or 60-90%, or approximately 70-80% by weight magnesium hydroxide. These ranges may provide an improvement in operating efficiencies which may be based on the relative proportion of magnesium hydroxide, metal hydroxide and water.

### Metal Hydroxide

The metal hydroxide may be a metal alkali.

The metal hydroxide described above is not magnesium hydroxide.

The metal hydroxide may be selected from: sodium hydroxide (NaOH), lithium hydroxide (LiOH), potassium hydroxide (KOH), calcium hydroxide (Ca(OH)₂), and combinations thereof.

As noted above, the presence of metal hydroxide appears to catalyse the reaction between magnesium hydroxide and CO₂, causing far higher CO₂ sequestration than for magnesium hydroxide alone. The listed metal hydroxides are abundant and relatively inexpensive hence why they may be useful to use. Other metal hydroxides may be used and this list should not be seen as limiting.

The soda magcite composition may comprise approximately 0.1-99%, or 1-95%, or 0.1-20%, or 1-10%, or approximately 5% by weight metal hydroxide. These ranges may provide an improvement in operating efficiencies which may be based on the relative proportion of magnesium hydroxide, metal hydroxide and water. Process efficiencies are capable of being modified to suit the requirements of chemical reactivity needed for end use applications (i.e. CO₂ reactivity and sequestration).

### Water

Water may be used to allow for reaction of magnesium hydroxide and metal hydroxides present, with CO₂ for carbon sequestration purposes. For example, the metal hydroxide may act as a catalyst to accelerate, or shift, or accelerate and shift, the reaction equilibrium of magnesium hydroxide with carbon dioxide to favour carbonation of the magnesium hydroxide Mg(OH)₂. Water may be needed to help this reaction by allowing intimate mixing of the compounds used.

The soda magcite composition may comprise at least approximately 1-99%, or 5-99%, or 5-95%, or 5-60%, or 5-35%, or approximately 20% by weight water. In one example, greater than approximately 5% by weight of the soda magcite composition is water. Moisture may be required to facilitate the uptake of CO₂ by soda magcite. Moisture content may be varied to change the workability and reactivity needed for end-user applications and products.

The amount of water present in the soda magcite composition may depend on the final form of the soda magcite composition.

### Pellet or Granule Form

The soda magcite composition may be configured as a pellet or granule. Pellets or granules may be useful for ease of handling.

The pellet or granule may approximately comprise (% by weight):
magnesium hydroxide from 1-99%, or 5-95%, or from 20-90%, or from 60-90%, or 70-80%, or approximately 75%;
metal hydroxide from 0.1-99%, or from 1-95%, or from 0.1-20%, or from 1-10%, or approximately 5%; and
water from 1-99%, or from 5-95%, or from 5-60%, or from 5-35%, or approximately 20%.

Relative percentages within the ranges described above may be used as described in other parts of this specification.

The pellets or granules produced may be approximately 1 μm to 10 mm, or 0.5 to 2 mm, or approximately 1 mm in diameter. Note that the term ‘diameter’ is used for brevity. The pellets or granules do not need to be round or spherical as alluded to by referring to diameter and the pellets or granules may take a variety of shapes all of a size within the ranges described.

### Slurry Form

The soda magcite composition may be configured as a slurry. Slurry configuration may be useful to reduce or prevent dust and inhalation handling issues. The solid content of the slurry may be variable. In one example, the solid content may be from 1-50%, or 1-40%, or 1-30%, or 1-20%, or 5-15%, or approximately 10% by weight. Liquid contents at these rates may be useful to allow the slurry to be mobilised for transfer.

The slurry may approximately comprise (% by weight):
magnesium hydroxide from 1-99%;
metal hydroxide from 0.1-99%; and
water from 5-99%.

Relative percentages within the ranges described above may be used as described in other parts of this specification.

### Silica Containing Materials

The soda magcite composition may further comprise silica containing materials. In one example, the silica containing materials if used, may be added as a powder. The silica containing materials may comprise less than approximately 50%, or 40%, or 30%, or 20%, or 10% by weight of the soda magcite composition.

The silica containing materials may be clays, quartz or other siliceous minerals.

The silica containing materials may be kaolin, smectite, bentonite or vermiculite.

The silica containing materials are understood by the inventors to increase the rate at which the soda magcite composition described above may sequester CO₂. Without being bound by theory, the mechanism for why silica containing materials increase sequestration rate may be because these materials give the soda magcite composition a higher void space, higher pore reaction area, and higher surface area for contact and reaction between the magnesium hydroxide and CO₂.

### Inert Materials

The soda magcite composition may further comprise inert materials. The inert materials may comprise: carbonates, silicates, oxides, and sulphates and combinations thereof. The inert materials may be selected from: clay minerals, quartz, zeolites, calcite, magnetite, magnesite and combinations thereof.

The inert materials used may be selected based on the ability of the inert material to increase the overall porosity of the soda magcite composition and improve the carbon sequestration rates of the soda magcite composition. The inert materials used may also be selected based on the ability of these materials to meet certain physical characteristics for the end product.

The soda magcite composition may comprise 5%, or 10%, or 15%, or 20% by weight inert materials. The soda magcite composition may approximately comprise 5-20%, or 10-20%, or 5-15%, or 15-20% by weight inert materials. The amount of inert materials present may be varied to allow for changes in porosity to meet the requirements of the end application for the soda magcite composition. The inventors have found that 5-20% by weight of inert materials may be suitable for many CO₂ sequestration applications.

### Metal Salts

The soda magcite composition may further comprise metal salts. Metal salts may be present in the soda magcite composition as residue from magnesium hydroxide manufacturing. By way of example, various metal salts may be used to produce the magnesium hydroxide and at least some of these metal salts may remain in the magnesium hydroxide material used to form the soda magcite composition.

The metal salts present in the soda magcite composition may be selected from: lithium chloride (LiCl), sodium chloride (NaCl), potassium chloride (KCl), magnesium chloride (MgCl₂), sodium sulphate (Na₂SO₄), magnesium sulphate (MgSO₄), calcium sulphate (CaSO₄), lithium sulphate (Li₂SO₄), calcium chloride (CaCl₂), and combinations thereof. Metal salts, if present, may comprise less than approximately 20%, or 19%, or 18%, or 17%, or 16%, or 15%, or 14%, or 13%, or 12%, or 11%, or 10%, or 9%, or 8%, or 7%, or 6%, or 5%, or 4%, or 3%, or 2%, or 1% by weight of the soda magcite composition. In the inventor's experience, metal salt concentrations above 20% by weight may impair the effectiveness/ability of soda magcite to react with CO₂.

In the inventors' experience, metal salts if present at low concentrations have minimal if any impact on the soda magcite composition activity in regards to CO₂ sequestration.

### Magnesium Oxide

The soda magcite composition may further comprise magnesium oxide (MgO). The magnesium oxide may also be present as a residue from magnesium hydroxide manufacturing. In the inventors experience, MgO if present has minimal if any impact on the soda magcite composition activity in regards to CO₂ sequestration.

### CO₂ During Manufacture

The soda magcite composition may have low to zero carbon emissions during production as it is made from silicate minerals that have no inherent CO₂, such as carbonate groups seen in the materials used to form other sequestration materials like soda lime.

The soda magcite composition may also react with carbon dioxide to capture and sequester carbon dioxide which is discussed further below.

### Comparison to Soda Lime

The soda magcite composition may have similar properties to soda lime and may be used interchangeably with soda lime. ‘Similar properties’ in the context of this specification refers to the ability of the soda magcite composition to sequester or reduce CO₂ preferentially and quickly, even at low concentrations. Soda lime, however, has the drawback that carbon dioxide is released from the soda lime manufacturing process. This means that later sequestration only results in a net neutral CO₂ effect (i.e. the amount of

CO₂ sequestered is similar to the amount produced to manufacture soda lime). By contrast, CO₂ is not released during soda magcite production and, hence, there may be a net benefit from the soda magcite composition to reduce CO₂ emissions to the atmosphere.

### Method of Manufacture—Magnesium Hydroxide—Any Source

In a second aspect, there is provided a method of manufacturing a soda magcite composition comprising:
selecting a magnesium hydroxide containing material;
selecting a metal hydroxide; and
mixing water with the magnesium hydroxide containing material and the metal hydroxide to form the soda magcite composition.

### Magnesium Hydroxide Containing Material

The magnesium hydroxide containing material may be produced via a processing method prior to completing this method or may be supplied prior to commencement of the above method.

As noted above, the magnesium hydroxide containing material may be present as Mg(OH)₂, or as a hydrate of magnesium hydroxide.

Other aspects about the magnesium hydroxide, metal hydroxide and water may be as described above and are not repeated here for brevity.

### Initial Grinding

Optionally, and if applicable, the magnesium hydroxide may be ground prior to the above method to produce an average particle size less than 1 mm. Particle sizes less than 1 mm may be useful as the surface area is higher and hence the reaction rate for CO₂ sequestration and manufacturing techniques to produce magnesium hydroxide will progress faster than lower surface area mixtures.

### Water Removal

Some water removal may occur from the soda magcite composition once produced.

Water removal may be via drying. Drying may be via methods including: filtration, conventional drying, and vacuum evaporation drying. Drying may be to reduce the water content.

Water removal noted above may result in greater than approximately 5%, or 10%, or 20%, or 30%, or 40%, or 50%, or 60%, or 70%, or 80%, or 90% by weight of water being removed from the soda magcite composition described above. As noted elsewhere, sufficient water removal may occur to produce a soda magcite composition with a water content of at least approximately 1-99%, or 5-99%, or 5-95%, or 5-60%, or 5-35%, or approximately 20% by weight water. Water removal to the extent described may be useful in order to decrease energy requirements for drying the materials where water is beneficial for reactivity, transport, and minimising dust/inhalation issues.

### Pellet/Granule or Slurry

The soda magcite composition produced above may be formed into a pellet or granule, or alternatively, into a slurry. The pellet, granule or slurry may have the characteristics noted earlier in this specification.

### Other Materials

The soda magcite composition produced may have further materials added comprising the silica containing materials, inert materials, and metal salts, described above.

### Method of Manufacture—Acid/Base Wash and Magnesium Salt Electrolysis

In a third aspect there is provided a method of manufacturing a soda magcite composition comprising:
selecting a magnesium containing silicate source;
subjecting the selected magnesium containing silicate source to acid wash, to produce an acid digested solution;
subjecting the acid digested solution to a base wash by adding a base solution to the acid digested solution to produce a magnesium salt solution and, during this step, removing silica, iron or other metals and minerals from the magnesium salt solution;
subjecting the magnesium salt solution to electrolysis to recover magnesium hydroxide;
mixing the recovered magnesium hydroxide with a solution containing metal hydroxide and water to produce the soda magcite composition.

### Magnesium Containing Silicate Source

As noted elsewhere in this specification, the magnesium containing silicate may be obtained from magnesium silicate bearing minerals comprising: olivine, serpentine group minerals, pyroxenes, and amphiboles. The magnesium silicate bearing minerals may be sourced as: sands, sediment, rock, and combinations thereof.

### Crushing and Grinding

The magnesium containing silicate may be crushed prior to processing above. Crushing may be to sand size or less than approximately 1 mm average diameter.

A portion of iron (if present) in the magnesium containing silicate may be removed from the raw magnesium containing silicate. Removal may be through magnetic separation. The magnetic iron may be recovered as a by-product.

Remaining magnesium containing silicate may be further ground. Grinding may be to a particle size of less than 100 μm. The ground magnesium containing silicate may be a finely ground magnesium containing silicate prior to processing in the above method. Iron removal (if needed) may also be completed using the finely ground magnesium containing silicate described.

Two grinding steps may be completed. The number of grinding steps completed may vary depending on the size and type of source material used. Two grinding steps may allow for easier removal of iron followed by a finer grinding to increase reactivity and dissolution rate of the magnesium containing silicate in the above method.

Note that the terms ‘crushing’ and ‘grinding’ are used herein, however, this should not be seen as limiting as the process relates to reducing particle size and increasing surface area which may be achieved by various methods not limited to use of a crusher or grinder.

### Acid Wash

Acid washing may be completed for example using an acid selected from hydrochloric acid (HCl) or sulphuric acid (H₂SO₄). These acids may be useful because they are easy to obtain and low cost. Other acids may be used and reference to HCl or H₂SO₄ should not be seen as limiting.

Acid washing may occur at an elevated temperature. The elevated temperature may be from approximately 40-95° C., or 50-90° C., or 60-85° C., or approximately 80° C. As the temperature increases, the acid effectiveness at washing also increases up to an optimum that in the inventor's experience is at around 80° C., although other temperatures may be used.

Acid washing may occur over a period of time. Acid washing may take place over approximately 1-24, or 1-12, or 1-6, or 1-5, or 1-4, or 1-3, or approximately 2 hours. Acid washing times may vary due to variable mineralogy of the magnesium containing silicate source material.

In the inventor's experience, the pH at the beginning of acid washing may be below pH 2 or even negative pH. Over time, and as the magnesium containing silicate is digested by the acid conditions, the pH may tend to rise. In one example, if olivine is acid washed in 2 M HCl at 80° C. for 2 hours then, after 2 hours, the pH becomes positive (to approximately 0.5 from less than zero).

There may be a further ripening step after the above acid wash where the pH is increased to pH 1 or greater, and left for another 1-24 hours. Ripening in this case may allow the silica to develop further prior to separation.

### Base Wash

The base solution may be selected from: lithium hydroxide (LiOH), sodium hydroxide (NaOH), potassium hydroxide (KOH), magnesium hydroxide (Mg(OH)₂), calcium hydroxide (Ca(OH)₂). Other metal hydroxides may also be used in the inventor's experience. Sodium hydroxide (NaOH) was typically used by the inventors as this is easily available and lowest cost.

Base washing may occur at an elevated temperature. An ‘elevated temperature’ may be a temperature above ambient conditions of approximately 15-25° C. The elevated temperature may be from approximately 40-95° C., or 40-80° C., or approximately 50-70° C.

Base washing temperatures may vary due to variable mineralogy of the magnesium containing silicate source material. At elevated temperatures, many of the magnesium-bearing silicate minerals will sufficiently react or react to an optimum extent.

Base washing may occur over a period of time. Base washing may take place over approximately 10 min-12 hours, or 10 min-3 hours, or 10-120 min, or 10-90 min, or, or less than 90 min. Base washing times may vary due to variable mineralogy of the magnesium containing silicate source material.

Base washing may occur in two steps. A first step may involve base washing for a first period of time (less than approximately 60 min) at which point the pH is increased to approximately 2 or greater. A second step may involve addition of further base solution and base washing for another time period at which point the pH may be increased to approximately 4 or greater to precipitate and remove silica and any precipitated iron. Two (or more) steps of base washing may be useful to allow for separation of side products from the reaction which may be collected as separate product streams. The time period for this second step may be less than approximately 24 hours, or less than 60, or 50, or 40, or 30, or 20, or 10 min.

### Electrolysis

As may be appreciated, electrolysis apparatus operating characteristics may vary depending on the device operating details. In one example, the inventors found that electrolysis apparatus used provided good separation at approximately 40-90° ° C., an electrical current density of at least approximately 0.1 kA/m² and with an anode being a mixed metal oxide titanium and the cathode being stainless steel or nickel.

Other materials could be used for the anode and cathode and reference to these materials are provided by way of illustration only. Similarly, other temperatures and electrical current densities could be used as well.

### Water Removal

At least some water removal may occur from the recovered magnesium hydroxide in the above method. Water removal may occur prior to soda magcite composition manufacture. Water removal may be via drying. Drying may be via methods including: air drying, filtration, conventional drying, vacuum evaporation drying, and combinations thereof.

Drying may be used to reduce the water content in this aspect as well. Water removal noted above may result in greater than approximately 5%, or 10%, or 20%, or 30%, or 40%, or 50%, or 60%, or 70%, or 80%, or 90% by weight of water being removed from the soda magcite composition described above. As noted elsewhere, sufficient water removal may occur to produce a soda magcite composition with a water content of at least approximately 1-99%, or 5-99%, or 5-95%, or 5-60%, or 5-35%, or approximately 20% by weight water.

### Method of Manufacture—Mineral Precipitation Using Metal Hydroxide Addition, Metal Salt Electrolysis Option

In a fourth aspect there is provided a method of manufacturing a soda magcite composition comprising:
selecting a magnesium containing silicate source;
subjecting the selected magnesium containing silicate to an acid wash, to produce an acid digested solution;
subjecting the acid digested solution to a first base wash by adding a base solution to the acid digested solution to produce a magnesium salt solution and, during this step, removing silica, iron or other metals and minerals from the magnesium salt solution;
completing a further base wash to separate magnesium hydroxide in solution;
filtering the separate magnesium hydroxide in solution and recovering a magnesium hydroxide retentate and a permeate, the permeate substantially comprising metal salt in solution;
mixing the recovered magnesium hydroxide retentate with a solution comprising metal hydroxide and water to produce the soda magcite composition.

### Magnesium Containing Silicate Source

As noted elsewhere in this specification, the magnesium containing silicate may be obtained from magnesium silicate bearing minerals comprising: olivine, serpentine group minerals, pyroxenes, and amphiboles and combinations thereof. The magnesium containing silicate may be sourced as: sands, sediment, rock, and combinations thereof.

### Acid Wash

Acid washing noted above may be completed in a similar manner to that described above.

### First Base Wash

The first base wash noted above may be completed in a similar manner to that described above. In one example, the first base wash may be completed in one step or in two steps. For example, a first base wash may comprise two base washes being to first remove the silica and second, to remove the iron. Silica removal may occur at a pH of approximately 2 or greater. Iron removal may occur at a pH of approximately 4 or greater.

Alternatively, the first base wash may occur in one step as one base wash to remove silica and iron together. In this example, the pH may be approximately 4 or greater.

### Further Base Wash

A further base wash may be used to precipitate and recover magnesium hydroxide Mg(OH)₂. This further base wash may in one example be completed using NaOH or other metal hydroxide.

Recovery may be by filtration, the retentate comprising the magnesium hydroxide and the permeate from the further base wash being primarily a sodium salt solution.

In this further base wash, the pH may be increased to approximately 10 or greater.

The further base wash may be maintained for a period of time of at least approximately 10 minutes, or 1 hour or up to approximately 2, 4, 6, 8, 10, 12, 14, 16, 18, 20, 22 or 24 hours (or possibly more) to ensure precipitation and development of the magnesium hydroxide.

The further base wash may be completed at a temperature from 20-90° C., or at approximately 20, or 25, or 30, or 35, or 40, or 45, or 50, or 55, or 60, or 65, or 70, or 75, or 80° C.

### Electrolysis

Electrolysis may be completed in the above method to recover reagents. Electrolysis is not needed to produce magnesium hydroxide via this method.

The permeate from the further base wash may as noted above substantially comprise metal salt in solution. The permeate metal salt in solution may undergo electrolysis to produce an acid solution and a base solution, and optionally evolved gases. The acid solution produced may be recycled for acid washing in the above method; and the base solution produced may be recycled for base washing in the above method.

For example, if hydrochloric acid is used for acid washing and sodium hydroxide is used for base washing, the metal salt may be sodium salt in solution and in the electrolyser, the sodium salt solution may be consumed and chlorine Cl₂ (gas) recovered from the anode and hydrogen H₂ (gas) and sodium hydroxide (NaOH) recovered from the cathode. The H₂ and Cl₂ gas may be combined to form hydrochloric acid HCl that may be recycled for use in acid wash described above.

If sulphuric acid (H₂SO₄) (optionally including NaHSO₄) is used for the acid washing process, then hydrogen and NaOH may be generated at the cathode and oxygen may be generated at the anode during the electrolysis of Na₂SO₄ (produced from reacting the MgSO₄ with NaOH). In addition a sulphuric acid (H₂SO₄) solution may also be generated at the anode. This may also be recycled for use for further acid wash steps.

Other acid/base wash solutions may also be used in the above method and electrolysis used to separate resulting metal salt in solution to acid and base solutions.

The electrolyser may operate using similar operating characteristics to the electrolyser described above.

### Washing

The recovered magnesium-hydroxide may be washed. Washing may be completed to remove contaminants and increase the purity of the magnesium hydroxide. The magnesium hydroxide may typically be washed with water using a counter current method to minimise water usage (i.e., recycled water used for first rinse and progressively cleaner water for final rinses).

### Other Steps

Other steps described above around the base and acid solutions, slurry or pellet/granule formation and use of other materials may also be used in this method but are not repeated here for brevity. By way of example, inert materials may be added as described further below including: carbonates, silicates, oxides, and sulphates and combinations thereof. The inert materials may be selected from: clay minerals, quartz, zeolites, calcite, magnetite, magnesite and combinations thereof.

### Method of Manufacture—Base Wash

In a fifth aspect there is provided a method of manufacturing a soda magcite composition comprising:
selecting a magnesium containing silicate source;
subjecting the selected magnesium containing silicate source to a base wash by adding a base solution to the magnesium containing silicate source to produce a magnesium hydroxide solution;
mixing the recovered magnesium hydroxide with a solution containing metal hydroxide and water to produce the soda magcite composition.

The base solution may be a metal hydroxide. In one example the base solution may be sodium hydroxide.

Magnesium hydroxide may form in solution during base washing as noted above. In one example, the resulting magnesium hydroxide may be at least partly separated from the liquid in the solution. Separation may be via decanting.

Silica, or iron, or both silica and iron, may also be removed from the magnesium hydroxide solution. Removal of silica and iron may occur prior to mixing the magnesium hydroxide with metal hydroxide and water.

### Sequestration

In a sixth aspect, there is provided a method of sequestration of carbon dioxide CO₂ by:
selecting a soda magcite composition, the soda magcite composition comprising magnesium hydroxide, metal hydroxide, and water;
exposing the soda magcite composition to CO₂; and
wherein the soda magcite composition reacts with the CO₂ to form stable magnesium carbonates and hydrated magnesium carbonates and hence sequesters the CO₂.

### Reaction

Magnesium hydroxide may naturally react with carbon dioxide CO₂ gas under both atmospheric (and near atmospheric) conditions and at elevated CO₂ levels, such as industrial point flue gas sources for example. This reaction forms stable magnesium carbonates and hydrated magnesium carbonates. This reaction, however, may not be a commercially optimal way to sequester significant volumes of CO₂. As noted elsewhere, mixing magnesium hydroxide with metal hydroxide and water accelerates the reaction process substantially, resulting in a commercially useful CO₂ sequestrant.

### Direct Air Capture or Point Source Capture

The inventors have found that the soda magcite composition is sensitive and reactive with CO₂ so that it may be used for direct air capture or capture about a point source. Exposure of the soda magcite composition in this environments directly captures CO₂ from the air hence the term direct air capture. This method of sequestration may be a useful passive means to sequester general CO₂ in the environment.

Point source capture may refer to exposing the soda magcite composition at or about a source of CO₂. Point sources may for example be from industrial sources, from residential sources or form commercial sources.

### Soda Magcite Composition Form

The soda magcite composition may be used in a partially dried form such as in pellets or granules or as a slurry with compositions substantially as described above.

### Reaction Rate

The rate of the reaction may be aided by an increase in CO₂ concentration and temperature. For example, the more CO₂ there is in the atmosphere or gas (e.g. exhaust gas) that the soda magcite composition is exposed to, the faster the reaction rate and CO₂ sequestration. This means that the soda magcite composition may be well suited to sequestration of high CO₂ producing sources.

The sequestration reaction rate may proceed more quickly when water is present. Water may be present as moisture. The moisture may be present at a moderate range of humidity. For example, at a relative humidity (RH) from 30-90%, or from 45-75%, or approximately 60%. Dry RH (low RH <40%) or very wet RH, >75% tends to be less effective in the inventor's experience for CO₂ sequestration rate although sequestration still occurs.

In the inventor's experience to date, approximately 1.3 tonnes of magnesium hydroxide in the described soda magcite composition may be required to sequester 1 tonne of CO₂ at 100% efficiency. The actual operating efficiency will be below 100%, hence, these figures are presented by way of example only and should not be seen as limiting.

### Capture Apparatus

The soda magcite composition described, may be incorporated into a method or apparatus or both method and apparatus, to increase mass transfer and mixing. The methods/apparatus may for example comprise: a fluidized bed, wet scrubber, dry scrubber, ambient exposure (spread on a field for example).

In point source applications, a slurry of soda magcite composition may be used in a wet scrubber configuration as one example where the slurry may be distributed as a fine mist in a column of hot gas about the point source. Alternatively, a dry scrubbed arrangement may use solid soda magcite composition such as a pellet or granule. This may be for example, in a fluidized bed type scrubber.

For direct air capture applications, solid soda magcite composition may be used where air may be passed over the magnesium material.

### Advantages

As noted above, the inventors have identified a soda magcite composition acts in a synergistic manner to sequester CO₂. Magnesium hydroxide materials do sequester CO_{2.}

The inventors found that by mixing metal hydroxide and water with magnesium hydroxide, the rate of CO₂ sequestration by the magnesium hydroxide may rapidly accelerate, to the point of being a rapid and useful method of reducing CO₂ emissions.

A further advantage identified is that the soda magcite composition may be made without the method itself producing CO₂ and hence negating any benefits of subsequent sequestration.

The examples described above may also be said broadly to consist in the parts, elements and features referred to or indicated in the specification of the application, individually or collectively, and any or all combinations of any two or more said parts, elements or features.

Further, where specific integers are mentioned herein which have known equivalents in the art to which the examples relate, such known equivalents are deemed to be incorporated herein as if individually set forth.

### WORKING EXAMPLES

The above described soda magcite composition, methods of manufacture and methods of CO₂ sequestration are now described by reference to specific examples.

### Example 1

An example soda magcite composition in the form of a pellet or granule produced by the inventors is demonstrated in Table 1 below:

TABLE 1
Example Pellet/Granule Soda Magcite Composition

| | | Amount (all |
|---|---|---|
| Compound | Details | by weight) |
| Magnesium | Obtained from magnesium | 5-95% |
| hydroxide | silicate bearing minerals | |
| | comprising: olivine, | |
| | serpentine group minerals, | |
| | pyroxenes, and | |
| | amphiboles. | |
| Metal hydroxide | E.g. NaOH, LiOH or | 1-95% |
| | KOH, Ca(OH)₂ | |
| Water | | 5-95% |
| Silica containing | Kaolin, smectite, bentonite | <50% |
| materials | or vermiculite | |
| Inert materials | E.g. magnesite, calcite, | <20% |
| | dolomite, siderite, clay | |
| | minerals, and zeolites | |
| Metal salts | E.g. LiCl, NaCl, KCl, | <10% |
| | MgCl₂, Na₂SO₄, MgSO₄ | |

The pellets or granules produced may be approximately 1 μm to 10 mm in diameter.

### Example 2

An example soda magcite composition in the form of a slurry produced by the inventors is demonstrated in Table 2 below:

TABLE 2
Example Slurry Soda Magcite Composition

| | | Amount (all |
|---|---|---|
| Compound | Details | by weight) |
| Magnesium | Obtained from magnesium | 1-99% |
| hydroxide | silicate bearing minerals | |
| | comprising: olivine, | |
| | serpentine group minerals, | |
| | pyroxenes, and | |
| | amphiboles. | |
| Metal hydroxide | E.g. NaOH, LiOH or | 0.1-99% |
| | KOH, Ca(OH)₂ | |
| Water | | 5-99% |
| Silica containing | E.g. kaolin, smectite, | <50% |
| materials | bentonite or vermiculite | |
| Inert materials | E.g. magnesite, calcite, | <20% |
| | dolomite, siderite, clay | |
| | minerals, and zeolites | |
| Metal salts | E.g. LiCl, NaCl, KCl, | <10% |
| | MgCl₂, Na₂SO4, MgSO₄ | |

### Example 3

In this example a basic method of producing a soda magcite composition is described by the steps of:
Selecting a magnesium hydroxide containing material. This material may be produced via a processing method described in further examples below or supplied in purified form prior to commencement;
Optionally, grind the magnesium hydroxide containing material to an average particle size less than 1 mm;
Selecting a metal hydroxide e.g. NaOH; and
Mixing water with the magnesium hydroxide containing material and the metal hydroxide together to form the soda magcite composition;
Optionally adding silica containing materials, inert materials, and metal salts, described above;
Optionally, remove water via drying;
Optionally, forming the soda magcite composition produced into a pellet or granule or a slurry.

### Example 4

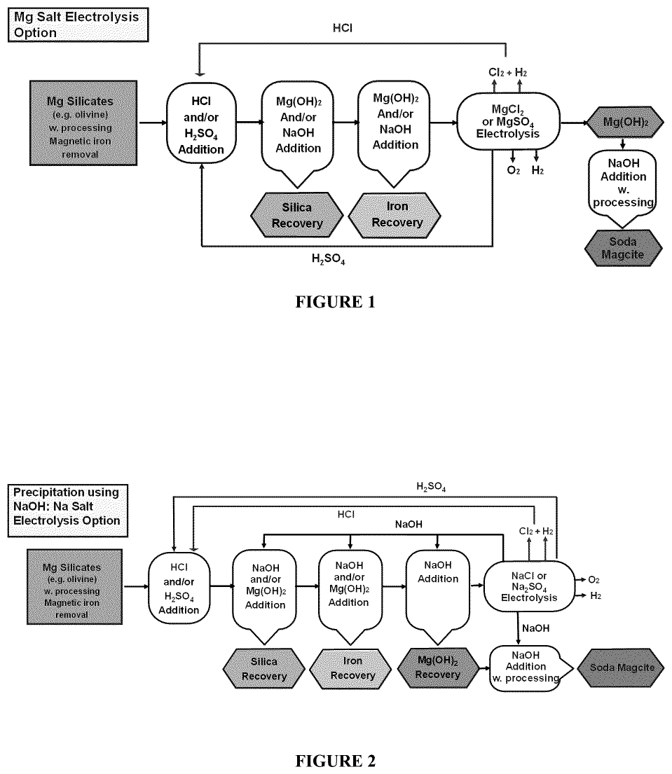

In this example a method of producing magnesium hydroxide is described along with subsequent manufacture of the above final soda magcite composition with reference to FIG. 1. Steps completed are as follows:
Selecting olivine as the magnesium containing silicate source as olivine sand or processed olivine-rich rock. In this example, the olivine is sourced with an average particle size of <1 mm;
Magnetic iron is removed from the olivine sand (approximately 13% of total mass of the olivine sand);
Olivine is then ground in a puck mill to produce average particle size of 30 μm;
An acid wash is completed at a rate of 50 g of ground olivine added to 500 ml of 2 M HCl acid. The acid wash is completed at 60° C. for approximately 3 hours;
A base wash is then completed by adding sodium hydroxide to bring pH up to approximately 2.5 to precipitate silica;
The solution produced is filtered and retentate (filter cake) washed;
Additional base solution (sodium hydroxide) is added to the permeate to bring the pH up to 6 to precipitate any remaining iron;
The solution is filtered and retentate (filter cake) washed;
The permeate produced is primarily ˜1 M magnesium chloride (MgCl₂) solution with some sodium chloride (NaCl) present;
The MgCl₂ solution is placed in an electrolyser and electrolysis completed. Chlorine (Cl₂) gas is recovered from the anode and hydrogen (H₂) gas is recovered from the cathode. Optionally, the gases evolved may be combined to form HCl acid for acid washing of further magnesium containing silicate source;
The magnesium hydroxide Mg(OH)₂ recovered from the cathode contains approximately 50% moisture;
Soda magcite composition is then produced by adding 2 g of sodium hydroxide NaOH powder to 10 g of recovered magnesium hydroxide Mg(OH)₂ to create high moisture content pellets.

Note that hydrochloric acid may be replaced with sulphuric acid or other acids in the above example.

### Example 5

In this example a method of producing magnesium hydroxide is described along with subsequent manufacture of the above final soda magcite composition with reference to FIG. 2. Steps completed are as follows:
Selecting olivine as the magnesium containing silicate source as olivine sand or processed olivine-rich rock. In this example, the olivine is sourced with an average particle size of <1 mm;
Magnetic iron is removed from the olivine sand (approximately 13% of total mass of the olivine sand);
Olivine is then ground in a puck mill to produce average particle size of 30 μm;
An acid wash is completed at a rate of 50 g of ground olivine added to 500 ml of 2 M HCl acid. The acid wash is completed at 60° C. for approximately 3 hours;
A first base wash is then completed by adding sodium hydroxide to bring pH up to approximately 2.5 to precipitate silica;
The solution produced is filtered and retentate (filter cake) washed;
Additional base solution (sodium hydroxide) is added to the permeate to bring the pH up to 6 to precipitate any remaining iron;
The solution is filtered and retentate (filter cake) washed;
A further base wash is the completed by adding base solution NaOH to the permeate to bring the solution pH up to 11 to precipitate magnesium hydroxide. The magnesium hydroxide produced has a moisture content of approximately 50%;
The solution is then filtered and retentate (filter cake) may be washed or left with residual NaOH. The permeate produced is primarily approximately 2 M NaCl solution;
Optionally, the permeate solution may be placed in an electrolyser and electrolysis completed. Chlorine (Cl₂) gas is recovered from the anode and hydrogen (H₂) gas is recovered from the cathode. Optionally the gases evolved may be combined to form HCl acid for acid washing of further magnesium containing silicate source;
The magnesium hydroxide Mg(OH)₂ recovered from the cathode contains approximately 50% moisture;
Soda magcite composition is then produced by drying (approximately 50% reduction in mass) of recovered Mg(OH)₂ to create 25% moisture content pellets. NaOH is also present due to additional base solution used in the magnesium-precipitation stage;
Additional NaOH may be added if necessary to the recovered Mg(OH)₂;
Silica or clay may also be added.

Note that hydrochloric acid may be replaced with sulphuric acid or other acids in the above example.

### Example 6

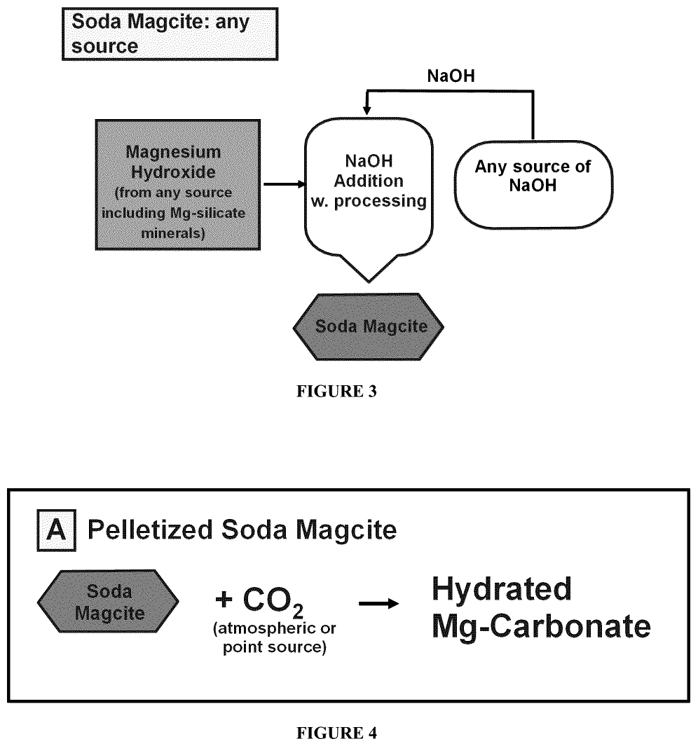

Referring to FIG. 3, an example of a method of producing soda magcite composition is described below by direct NaOH addition (note: this differs from base washing described in other examples where washing causes a pH increase for the purpose of product separation):
Magnesium hydroxide is obtained from any source (i.e. commercially available).
If applicable, the magnesium hydroxide can be ground to produce an average particle size less than 1 mm.
A solution containing a mixture of NaOH (or other metal hydroxide) with water can be added to the Mg-hydroxide. The metal hydroxide concentration of the solution is adjusted to produce a final material with a composition as described in table 1 (pelletized) or table 2 (slurry).
Alternatively, solid NaOH is combined with Mg-hydroxide and water added to achieved the composition outlined in Table 1 and Table 2.
Clays, silica or other material may be added to the mixture.
The mixture maybe processed into pellets. The pellets will typically be approximately 1 mm in diameter (but may be 1 μm to 10 mm).
Alternatively, the mixture can be maintained in slurry.

### Example 7

Referring to FIGS. 4-8, methods of CO₂ sequestration are described using soda magcite composition.

### Direct Air Capture

Typically, soda magcite composition may be used where air is passed over the soda magcite composition. FIG. 4 illustrates this reaction where the soda magcite composition is in a pelletised form and naturally reacts with carbon dioxide gas (atmospheric or point source) to produce a hydrated magnesium carbonate end product.

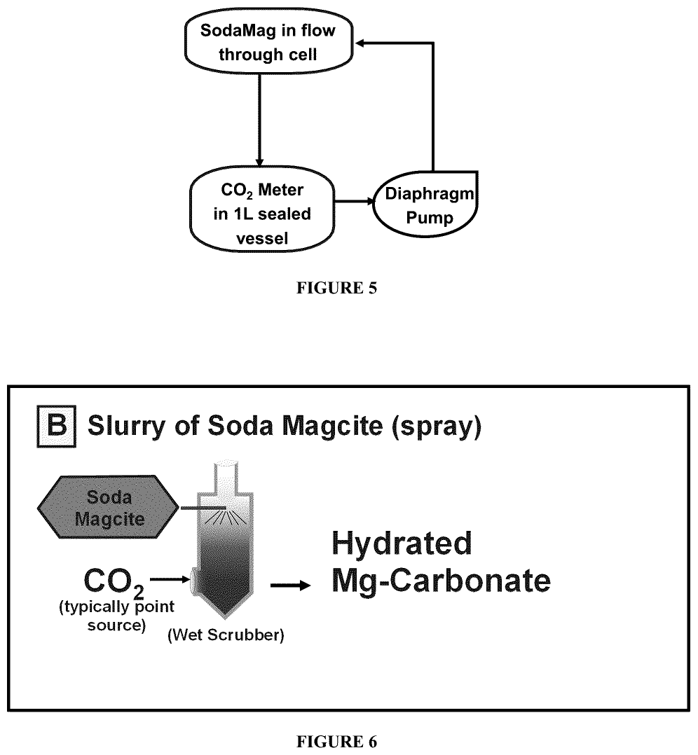

The above reaction may occur using an apparatus as shown in FIG. 5. In an experiment completed by the inventors using the apparatus of FIG. 5 as a closed system, a first measurement was a control where no soda magcite composition was added to the flow through the cell shown. Steady state atmospheric CO₂ readings of approximately 400 ppm were recorded. 5 g of pelletised soda magcite composition was placed in the flow through cell and readings then taken over time of the CO₂ levels. The CO₂ readings decreased from a starting value of approximately 400 ppm to less than 200 ppm over 24 hours illustrating the CO₂ absorbing properties of the soda magcite composition.

### Point Source Carbon Capture

As an alternative, a slurry of soda magcite composition may be used in a wet scrubber configuration where the slurry is distributed as a fine mist in a column of hot gas as illustrated in FIG. 6.

In a further alternative method, a dry scrubbed arrangement may use a pelletised soda magcite composition (for instance in a fluidised bed type scrubber). To demonstrate the carbon absorption reaction for this alternative method, an experiment was completed by the inventors as follows:
˜5 grams of soda magcite composition was placed in a beaker containing deionised water;
Concentrated CO₂ (˜99%) was passed through the cell for a period of approximately 1 hour.

Following the addition of CO₂, the thermogravimetric analysis results and acid test verified the presences of a highly carbonated material demonstrating carbon absorption.

### Aqueous Carbon Capture

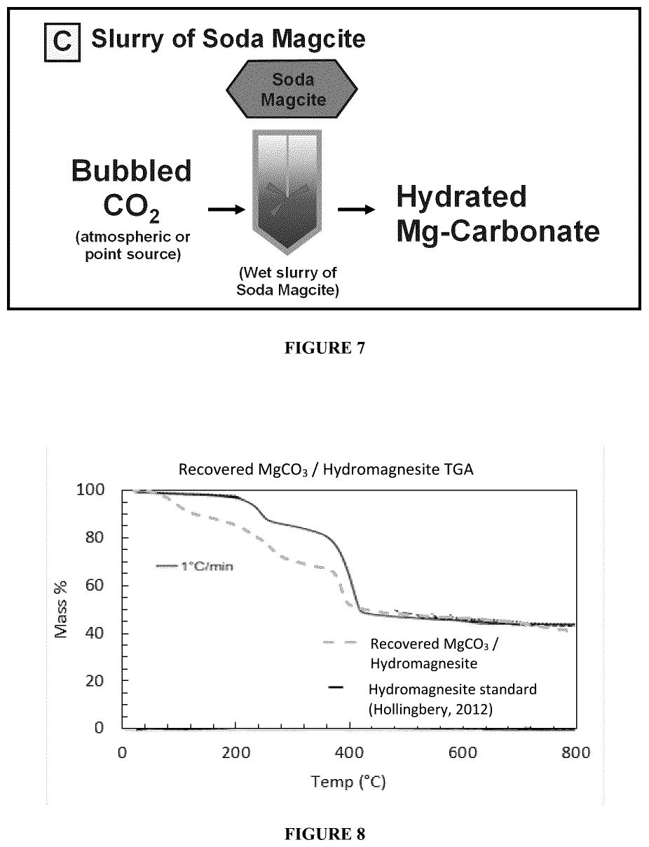

A further method for sequestration may be via bubbling of CO₂ through a slurry containing soda magcite composition as illustrated in FIG. 7.

To further illustrate this method of sequestration, an experiment was completed as follows:
˜21 grams of soda magcite composition was placed in a beaker containing deionised water,
Concentrated CO₂ (˜99%) was bubbled through the beaker for a period of ˜15 minutes.

The thermogravimetric results after exposure of the soda magcite composition to CO₂ bubbling shown in FIG. 8, illustrates the material was a hydrated magnesium carbonate similar to hydromagnesite.

Aspects of the soda magcite composition, methods of manufacture and methods of CO₂ sequestration have been described by way of example only and it should be appreciated that modifications and additions may be made thereto without departing from the scope of the claims herein.

What is claimed is:

1. A magnesium based hydrate composition comprising a mixture of:
60-90% by weight of magnesium hydroxide containing material;
0.1-20% by weight of metal hydroxide selected from: NaOH, LiOH or KOH, Ca(OH)₂, and combinations thereof; and
greater than 5% water;
wherein the magnesium based hydrate composition is configured to catalyse sequestration of carbon to the magnesium hydroxide containing material.

2. The magnesium based hydrate composition as claimed in claim 1 wherein the magnesium hydroxide is obtained from magnesium silicate bearing minerals comprising:
olivine, serpentine group minerals, pyroxenes, amphiboles, and combinations thereof.

3. The magnesium based hydrate composition as claimed in claim 1 wherein the magnesium based hydrate composition comprises 1-10% by weight metal hydroxide.

4. The magnesium based hydrate composition as claimed in claim 1 wherein the magnesium based hydrate composition is configured as a pellet or a granule.

5. The magnesium based hydrate composition as claimed in claim 4 wherein the pellets or granules produced are approximately 1 μm to 10 mm in size.

6. The magnesium based hydrate composition as claimed in claim 1 wherein the magnesium based hydrate composition is configured as a slurry.

7. The magnesium based hydrate composition as claimed in claim 6 wherein the slurry has a solids content of 1-50% by weight.

8. The magnesium based hydrate composition as claimed in claim 6 wherein the slurry has a solids content of 5-15% by weight.

9. The magnesium based hydrate composition as claimed in claim 1 further comprising silica containing materials, the silica containing material comprising less than approximately 50% by weight of the magnesium based hydrate composition and wherein the silica containing materials are configured to increase sequestration of carbon to the magnesium hydroxide containing material.

10. The magnesium based hydrate composition as claimed in claim 9 wherein the silica containing materials are clays, quartz or other siliceous minerals.

11. The magnesium based hydrate composition as claimed in claim 9 wherein the silica containing materials are selected from: kaolin, smectite, bentonite, vermiculite, and combinations thereof.

12. The magnesium based hydrate composition as claimed in claim 1 further comprising 5-20% by weight inert materials selected from: carbonates, silicates, oxides, sulphates and combinations thereof, these inert materials configured to increase overall porosity of the magnesium hydroxide containing material and increase the rate of sequestration of carbon to the magnesium hydroxide containing material.

13. The magnesium based hydrate composition as claimed in claim 12 wherein the inert materials are selected from: clay minerals, quartz, zeolites, calcite, magnetite, magnesite, and combinations thereof.

14. The magnesium based hydrate composition as claimed in claim 1 further comprising metal salts selected from: LiCl, NaCl, KCl, MgCl₂, Na₂SO₄, MgSO₄, CaSO₄, Li₂SO₄, CaCl₂ and combinations thereof.

15. The magnesium based hydrate composition as claimed in claim 14 comprising less than 20% by weight metal salts.

16. A magnesium based hydrate composition comprising a mixture of:
60-90% by weight of magnesium hydroxide containing material;
silica containing materials, the silica containing material comprising less than approximately 50% by weight of the magnesium based hydrate composition;
greater than 5% water;
wherein the magnesium based hydrate composition is configured to catalyse sequestration of carbon to the magnesium hydroxide containing material.

17. The magnesium based hydrate composition as claimed in claim 18 further comprising 5-20% by weight inert materials selected from: carbonates, silicates, oxides, sulphates and combinations thereof.

18. A magnesium based hydrate composition comprising a mixture of:
60-90% by weight of magnesium hydroxide containing material;
5-20% by weight inert materials selected from: carbonates, silicates, oxides, sulphates and combinations thereof, these inert materials configured to increase overall porosity of the magnesium hydroxide containing material;
greater than 5% water;
wherein the magnesium based hydrate composition is configured to catalyse sequestration of carbon to the magnesium hydroxide containing material.

19. A soda magcite composition comprising:
magnesium hydroxide;
metal hydroxide; and
water.

20. The soda magcite composition as claimed in claim 19 wherein the magnesium hydroxide is obtained from magnesium silicate bearing minerals comprising: olivine, serpentine group minerals, pyroxenes, amphiboles, and combinations thereof.

21. The soda magcite composition as claimed in claim 19 wherein the soda magcite composition comprises approximately 1-99% by weight magnesium hydroxide.

22. The soda magcite composition as claimed in claim 19 wherein the metal hydroxide is a metal alkali and is not magnesium hydroxide.

23. The soda magcite composition as claimed in claim 19 wherein the metal hydroxide is selected from: NaOH, LiOH or KOH, Ca(OH)₂, and combinations thereof.

24. The soda magcite composition as claimed in claim 19 further comprising approximately 0.1-99% by weight metal hydroxide.

25. The soda magcite composition as claimed in claim 19 further comprising at least approximately 1-99% by weight water.

26. The soda magcite composition as claimed in claim 19 wherein the soda magcite composition is configured as a pellet, a granule, or a slurry.

27. The soda magcite composition as claimed in claim 19 further comprising silica containing materials, the silica containing material comprising less than approximately 50% by weight of the soda magcite composition.

28. The soda magcite composition as claimed in claim 27 wherein the silica containing materials are clays, quartz or other siliceous minerals.

29. The soda magcite composition as claimed in claim 19 further comprising inert materials selected from: carbonates, silicates, oxides, sulphates and combinations thereof

30. The soda magcite composition as claimed in claim 19 further comprising inert materials selected from: clay minerals, quartz, zeolites, calcite, magnetite, magnesite and combinations thereof.

31. The soda magcite composition as claimed in claim 19 further comprising metal salts selected from: LiCl, NaCl, KCl, MgCl₂, Na₂SO₄, MgSO₄, CaSO₄, Li₂SO₄, CaCl₂ and combinations thereof.

32. The soda magcite composition of claim 19 wherein said soda magcite composition is configured to be exposed to CO₂; and wherein the soda magcite composition is configured to react with said CO₂ to form stable magnesium carbonates and hydrated magnesium carbonates and hence sequesters CO₂.
